(19) United States
(12) Patent Application Publication
(10) Pub. No.: US 2022/0102738 A1
(43) Pub. Date: Mar. 31, 2022

(54) NON-CHANNELED AND ANISOTROPIC FLOW FIELD FOR DISTRIBUTION SECTIONS IN FUEL CELLS

(71) Applicant: HYZON MOTORS INC., Honeoye Falls, NY (US)

(72) Inventors: Arthur E. Koschany, Yuhong Xingtian (CN); Jie Chen, Shanghai (CN)

(21) Appl. No.: 17/485,629

(22) Filed: Sep. 27, 2021

Related U.S. Application Data
(60) Provisional application No. 63/084,157, filed on Sep. 28, 2020.

(51) Int. Cl. H01M 8/0258; H01M 8/24; H01M 8/0232

(52) U.S. Cl. CPC H01M 8/0258; H01M 2220/20; H01M 8/0232; H01M 8/24

(57) ABSTRACT

A fuel cell has an active area and a distribution area. The distribution area can be in communication with and disposed substantially adjacent to the active area. The active area can include a non-channeled material exhibiting anisotropic flow. In certain circumstances, the non-channeled material exhibiting anisotropic flow can include expanded metal sheet. The expanded metal sheet can achieve even distribution to throughout the active area without the use of conventional channels.

### CROSS-REFERENCE TO RELATED APPLICATIONS

This application claims the benefit of U.S. Provisional Application. No. 63/084,157 filed on Sep. 28, 2020. The entire disclosure of the above application is hereby incorporated herein by reference.

### FIELD

The present disclosure relates generally to fuel cells, and more particularly, to distribution areas of fuel cells.

### INTRODUCTION

This section provides background information related to the present disclosure which is not necessarily prior art.

Fuel cell systems are currently being developed for use as power supplies in numerous applications, such as vehicles and stationary power plants. Such systems offer promise of delivering power economically and with environmental and other benefits. To be commercially viable, however, fuel cell systems should exhibit adequate reliability in operation, even when the fuel cells are subjected to conditions outside their preferred operating ranges.

Fuel cells convert reactants, namely, fuel and oxidant, to generate electric power and reaction products. Polymer electrolyte membrane fuel cells (PEM fuel cell) employ a membrane electrode assembly (MEA), which includes a polymer electrolyte or ion-exchange membrane disposed between two electrodes, namely a cathode and an anode. A catalyst typically induces the desired electrochemical reactions at the electrodes. Separator plates or bipolar plates, including plates providing a flow field for directing the reactants across a surface of each electrode substrate, are disposed on each side of the MEA.

In operation, the output voltage of an individual fuel cell under load can be below one volt. Therefore, in order to provide greater output voltage, multiple cells can be stacked together and can be connected in series to create a higher voltage fuel cell stack. End plate assemblies can be placed at each end of the stack to hold the stack together and to compress the stack components together. Compressive force can provide sealing and adequate electrical contact between various stack components. Fuel cell stacks can then be further connected in series and/or parallel combinations to form larger arrays for delivering higher voltages and/or currents.

In particular, the bipolar plates can include a plurality of lands and flow channels for distributing the gaseous reactants to the anodes and cathodes of the fuel cell. The bipolar plates serve as an electrical conductor between adjacent fuel cells and are further provided with a plurality of internal coolant channels adapted to exchange heat with the fuel cell when a coolant flows therethrough.

However, flow channels of the bipolar plate can require comparatively large amounts of area in the fuel cell in order to achieve uniform flow of reactant fluid to the active area. Accordingly, there is a continuing need for a distribution area of a fuel cell, which achieves uniform flow to the active area without the use of channels.

### SUMMARY

In concordance with the instant disclosure, a fluid pathway of a fuel cell, which achieves uniform flow to the active area without the use of channels, has surprisingly been discovered.

A fuel cell is provided that has a pathway fluidly coupling an inlet header to an outlet header. A non-channeled material exhibiting anisotropic flow is disposed within the pathway. The material exhibiting anisotropic flow is disposed at an active area of the fuel cell, and in certain embodiments, can be disposed only at the active area of the fuel cell. The material exhibiting anisotropic flow can be disposed at a distribution area of the fuel cell, and in certain embodiments, can be disposed only the distribution area of the fuel cell.

In certain embodiments, the material exhibiting anisotropic flow includes a plurality of voids, where each void can have a short axis and a long axis. A flow resistance in a direction of the short axis can be higher than a flow resistance in a direction of the long axis. Accordingly, the flow resistance between the short axis and the long axis can have a ratio between about two to one and about three to one.

In certain embodiments, a fuel cell can have an active area and a distribution area. The distribution area can be in fluid communication with the active area. The distribution area can include one or more expanded metal sheets that provide anisotropic flow thereby or therethrough. Orientations of one or more expanded metal sheets can optimize fluid distribution to the active area of the fuel cell without the use of conventional channels and flow fields.

Further areas of applicability will become apparent from the description provided herein.

The description and specific examples in this summary are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described herein.

FIG. 1 is an exploded schematic perspective view of an embodiment of a fuel cell according to the present technology;

FIG. 2 is the fuel cell having an active area including an expanded metal sheet with rhombic shaped voids, according to an embodiment of the present technology;

FIG. 3 is a fuel cell having an active area and distribution areas including expanded metal sheets with rhombic shaped voids, according to another embodiment of the present technology;

FIG. 4 is an enlarged view of the expanded metal sheet, further depicting the rhombic shaped voids oriented with a long-axis of the rhombic shaped voids disposed substantially parallel with a longitudinal length of the fuel cell; and

FIG. 5 is an enlarged view of the expanded metal sheet, further depicting the rhombic shaped voids oriented with a long-axis of the rhombic shaped voids disposed substantially parallel with a latitudinal length of the fuel cell.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as can be filed claiming priority to this application, or patents issuing therefrom.

Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

As used herein, the term “active area” refers to an area of a fuel cell where necessary components for the fuel cell operation are available, namely, hydrogen, air or oxygen, coolant, polymer electrolyte membrane, catalyst, electrical conductor (e.g., diffusion media), and electrical contact (e.g., all necessary components under compression). Feed regions of nested plates are not typically part of the active area, nor are gasket or sealant areas. The active area includes where distributed reactant fluids can participate in electrochemical reactions that contribute to operation of the fuel cell.

A flow distribution section can be located before and/or after the active area in the fuel cell. In other words, the distribution sections can be disposed substantially adjacent to the active area. It should be appreciated that certain materials are better suited for the distribution sections than other materials. It is advantageous to achieve uniform flow in the active area by sacrificing minimum area for the distribution sections.

An inlet header and an outlet header can be fluidly coupled along a flow pathway of a fuel cell. In certain circumstances, the active area and one or more distribution areas can be provided between the inlet header and the outlet header. In a specific example, the distribution area can include a first distribution area disposed at the inlet header and a second distribution area disposed at the outlet header, and the first distribution area and the second distribution area are disposed at terminal ends of the active area of the fuel cell.

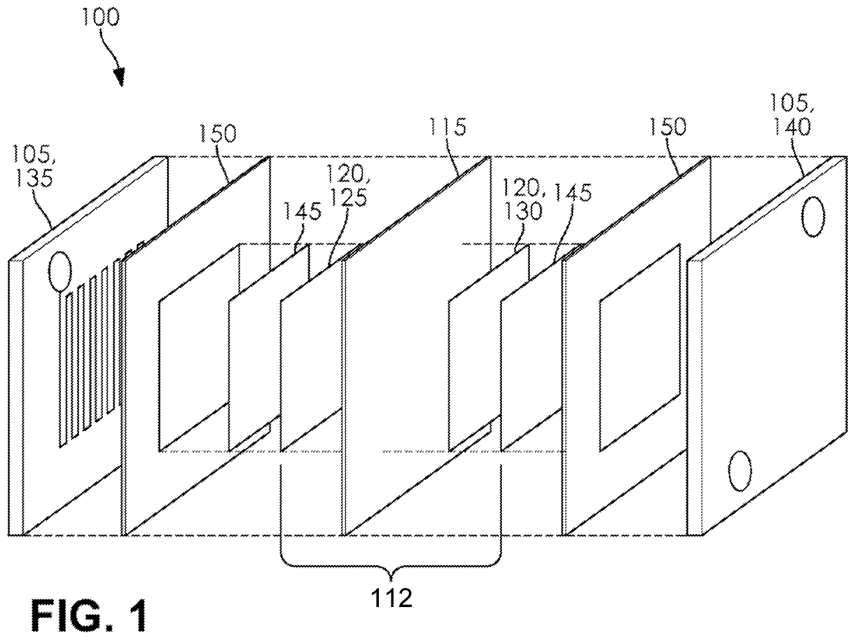

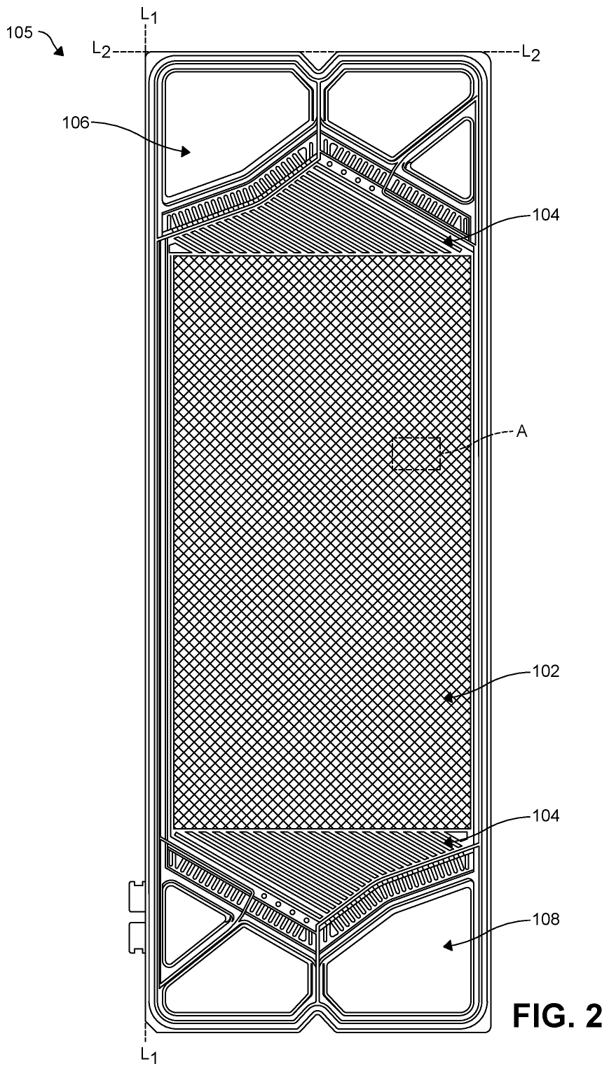

In certain circumstances, the fuel cell can have an active area including a non-channeled material exhibiting anisotropic flow therethrough. In a specific example, the fuel cell can have a channeled distribution section disposed substantially adjacent to the active area. As shown in FIG. 1, the flow in the upper distribution section can be guided to the right of the fuel cell in order to achieve uniform flow in the active area. Alternatively, as shown in FIG. 2, the distribution section can also include a non-channeled flow field that possesses anisotropic flow resistance, and can allow for uniform flow through the active area. It is also contemplated that a plurality of fuel cells having a non-channeled material exhibiting anisotropic flow can be disposed on top of one another to form a fuel stack. Certain applications of the present technology can include providing energy systems for vehicles.

The fuel cell can include one or more of the following configurations. The material exhibiting anisotropic flow can be disposed only at the active area of the fuel cell. The material exhibiting anisotropic flow can be disposed only at the distribution area of the fuel cell. The material exhibiting anisotropic flow can be disposed at both the active area and the distribution area of the fuel cell.

A material with anisotropic flow allows a fluid to travel with less resistance and less pressure drop in a first direction, and allows the fluid to travel with more resistance in a second direction. The material exhibiting anisotropic flow can be porous. Specifically, the material exhibiting anisotropic flow can include fine structured mesh-like materials which advantageously provide enhanced support for gas diffusion layers (GDLs) and sub-gaskets. The material exhibiting anisotropic flow can be used in the distribution and/or passage of reactant fluids (e.g., hydrogen, oxygen, or air) across portions of the fuel cell, including an active area of the fuel cell as well as one or more distribution areas of the fuel cell. The material exhibiting anisotropic flow can also be used in the distribution and/or passage of a coolant fluid in the fuel cell; e.g., the pathway can include a coolant pathway. In a specific example, an expanded metal sheet works in conjunction with a GDL to fluidly couple the inlet header to the outlet header and provide anisotropic flow.

An example of a material that can provide such anisotropic flow includes an expanded metal sheet. Expanded metal sheets can include voids with approximately rhombic shapes or elliptic shapes. The flow resistance along a long axis of the voids can be low, whereas the flow resistance in a direction of a short axis can be high in comparison, or in other words, the flow resistance in a direction of the short axis can be higher than a flow resistance along the long axis. The ratio of the flow resistance in the two directions can be about 2:1 to about 3:1, depending on the dimensions of the voids. The dimensions of the voids can be tailored to adjust the anisotropic flow. For example, a greater flow ratio can be obtained by increasing the long axis of the voids and/or decreasing the short axis of the voids. One skilled in the art can select other suitable shapes to form the voids, within the scope of the present disclosure.

Expanded metal sheets can be formed in various ways. In certain embodiments, expanded metal sheets can be manufactured from solid sheets/coils of stainless steel, aluminum, carbon steel, and other alloys that can be expanded. The solid sheet is subjected to slitting and stretching by a set of dies with an upper blade and a lower blade, while the shape of the resultant voids can be directed by the shape of the dies, in part. The solid metal sheet can be slit using the dies and stretched to form the expanded metal sheet without generation of waste. That is the slits can be formed in the solid sheet without punching out portions of the sheet. The solid sheet can be fed into an expanding machine, where the precision dies can cut and stretch the metal in a single operation. The material can then be sheared and stretched into a particular pattern with uniform sized openings or voids. Certain embodiments include where the original solid metal sheet can be expanded up to ten times its original width, and the final expanded metal sheet can be lighter per area and stronger per weight than the original solid sheet. No material may be lost in the manufacturing process. The expanded metal sheet may not unravel and the strand intersections can hold the sheet together when the expanded sheet is cut to desired dimensions. A thickness of the expanded metal sheet can be controlled using a rolling mill, as desired.

In certain circumstances, where the expanded metal sheet is used to form the material exhibiting anisotropic flow, the fuel cell can be configured to permit the inlet header to be fluidly coupled to the outlet header. For instance, pathway can include a gap or space adjacent the expanded metal sheet so the reactant fluid can travel between the space and the voids. As a non-limiting example, the space can be provided by a gasket and/or the gas diffusion layer. In a specific example, the gasket and/or the gas diffusion layer can include a plurality of gaskets and/or a plurality of gas diffusion layers disposed substantially above and/or below the expanded metal sheet. The expanded metal sheet can work in conjunction with the gas diffusion layer to provide anisotropic flow in the pathway fluidly coupling the inlet header to the outlet header. For instance, where the gas diffusion layer is provided adjacent to the expanded metal sheet, the reactant fluid can travel between one void of the expanded metal sheet by flowing through the pores of the gas diffusion layer and then back to an adjacent void of the expanded metal sheet. One skilled in the art can select other suitable methods of fluidly coupling the inlet header to the outlet header using the expanded metal sheet, within the scope of the present disclosure.

The material exhibiting anisotropic flow can be used to replace the reactant fluid distribution channels used in distribution areas and flow fields of certain fuel cells. The low flow resistance direction can be the horizontal left-right direction, or in other words, the long axis direction can be substantially parallel with a latitudinal length of the fuel cell. In the active area, the low flow resistance direction can be a vertical up-down direction, or in other words, the long axis direction can be substantially parallel with a longitudinal length of the fuel cell. It can be useful to change the low flow resistance direction steadily from a horizontal direction to a vertical direction by continuously changing the long axis direction of the voids within the fuel cell. Accordingly, the long axis direction of the voids and the short axis direction of the voids can be alternated at least one time within the fuel cell. The long axis direction of the voids can alternate directions across the fuel cell between being disposed substantially parallel with the longitudinal length and being disposed substantially parallel the latitudinal length of the fuel cell. Specifically, the long axis direction can be rotated in a single direction over a length of the fuel cell, as needed to change the direction of the low flow resistance. Additionally, the long axis direction and the short axis direction can be alternated more than one time, as needed, to change the direction of the low flow resistance within the fuel cell.

Besides expanded metal sheets, some fibrous sheet materials and some types of woven metal mesh can provide anisotropic flow behavior and can be used as the material exhibiting anisotropic flow.

In certain embodiments, the material exhibiting anisotropic flow can include areas of the fuel cell that were previously used for distribution of reactant fluids to the active area of the fuel cell. For example, certain separator plates of bipolar plates can be designed with distribution regions connecting reactant fluid headers to flow fields at the active areas of the fuel cell. The present technology can include use of the material exhibiting anisotropic flow at such distribution regions in addition to the active area. For example, the reactant fluid can flow from a respective inlet fluid header into a material exhibiting anisotropic flow where a long axis of the voids in a latitudinal direction to first spread the fluid from the inlet header across a width of the fuel cell. A transition can then be provided to have the material exhibiting anisotropic flow change the direction of the long axis of the voids to a longitudinal direction to then spread the fluid across a length of the fuel cell. Another transition can then be provided to have the material exhibiting anisotropic flow change the direction of the long axis of the voids back to the latitudinal direction to then direct the fluid from across the width of the fuel cell to an outlet header.

By providing the material exhibiting anisotropic flow in such former distribution areas, it is also possible to expand the active area of the fuel cell to include such former distribution areas. For example, former distribution areas of the fuel cell can be combined with the active area. This can be done by expanding or shaping the active area to include the former distribution areas for the anode and/or cathode reactant fluids. In this way, the shape of the MEA, including one or both of the electrodes (e.g., anode and cathode) can include the former distribution areas. Likewise, the shape of GDLs, where present, can include the former distribution areas. In certain embodiments, the MEA (and GDLs) can be expanded from a former quadrilateral shaped active area generally in the middle of the fuel cell layout to now include the substantially triangular shaped distribution areas used to fluidly couple the reactant fluid inlet and outlet headers. It is also possible to replace any distribution areas between coolant inlet and outlet headers with the material exhibiting anisotropic flow in a similar manner.

Turning now to the several figures provided herewith, certain embodiments of the present technology are presented in relation thereto. With reference to FIG. 1, an embodiment of a fuel cell 100 constructed in accordance with the present technology is shown in an exploded schematic perspective view. The fuel cell 100 can include a pair of plates 105, which can be separator plates of bipolar plates in a fuel cell stack or end plates at the end of a fuel stack or a single fuel cell. The plates 105, as shown in FIG. 1, are provided for contextual reference pertaining to the construction of the fuel cell 100. The plates 105, as shown in FIG. 1, are not intended to provide a specific configuration of the plates 105 themselves. The plates 105 can operate to distribute reactant fluids and collect electrical current generated in operation of the fuel cell 100. The plates 105 can sandwich a membrane electrode assembly (MEA) 112, where the MEA 112 incudes a proton exchange membrane 115 flanked by electrodes 120. The proton exchange membrane 115 can be configured to be permeable to protons while acting as an electric insulator and reactant fluid barrier, e.g., militating against the passage of oxygen and hydrogen. The electrodes 120 can include an anode 125 and a cathode 130, where hydrogen can be supplied to the anode 125 and oxygen or air can be supplied to the cathode 130, each of the electrodes 120 including a catalyst to facilitate the electrochemical conversion of hydrogen to protons at the anode 125 and the oxygen reduction reaction of the protons at the cathode 130. The plates 105 can be used to distribute the reactant fluids for the fuel cell 100 using reactant fluid channels and flow fields formed therein, where one of the plates 105, 135 can distribute the hydrogen to the anode 125 and the other of the plates 105, 140 can distribute the oxygen or air to the cathode 130. Gas diffusion layers 145 can be positioned between the electrodes 120 and the plates 105 in order to facilitate distribution of the reactant fluids. As shown, the gas diffusion layers 145 can be separate components. However, certain embodiments can include where the gas diffusion layers 145 and the electrodes 120 can be integrated. Gaskets 150 can be used to provide a fluid-tight seal between the plates 105 and the MEA 112, effectively sealing the distribution of reactant fluids from the plates 105, through the gas diffusion layers 145, to the respective electrodes 120 flanking the proton exchange membrane 115. It should be appreciated that other types of sealing mechanisms can be used in place of the gaskets 150.

As shown in FIG. 2, the plates 105 includes an active area 102, two distribution areas 104, an inlet header 106, and an outlet header 108. The plates 105 can include a pathway fluidly coupling the inlet header 106 to the outlet header 108. In the embodiment shown, the pathway includes the active area 102 and the two distribution areas 104. A non-channeled material exhibiting anisotropic flow can be disposed within the pathway.

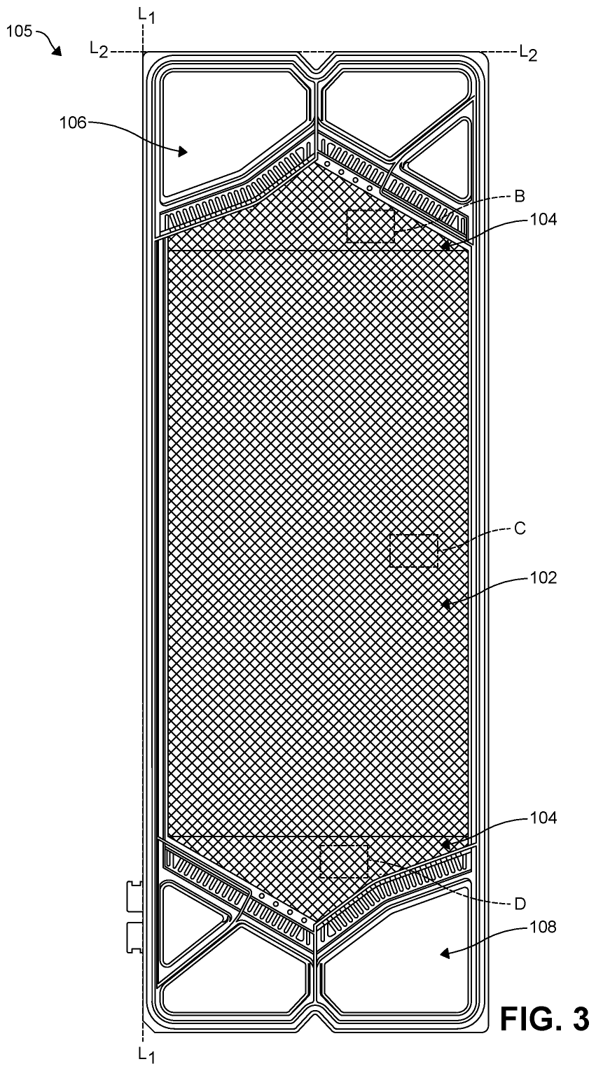

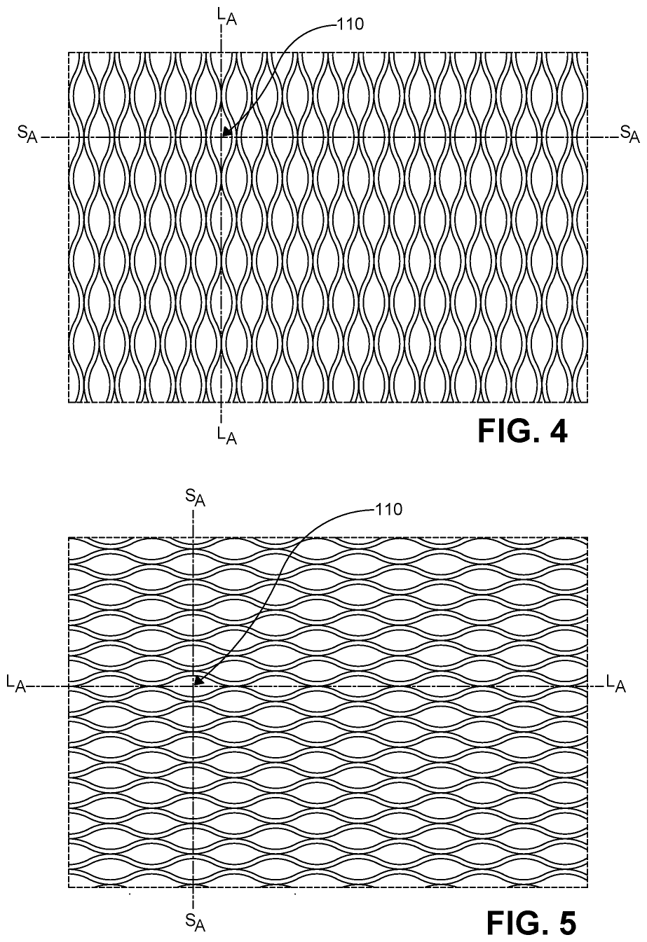

As shown in FIG. 2, the active area 102 can include the non-channeled material exhibiting anisotropic flow. As shown in FIG. 3, the distribution areas 104 can also include the non-channeled material exhibiting anisotropic flow. With reference to FIGS. 2-3, the fuel cell 100 includes a longitudinal length L1 and a latitudinal length L2. With continued reference to FIGS. 2-3, the areas of the fuel cell 100 provided with the non-channeled material exhibiting anisotropic flow are depicted by a crosshatch pattern. The general crosshatch pattern in the active area 102 of FIG. 2 and the active area 102 and the distribution area 104 of FIG. 3 can take various forms and orientations, as further described herein, and as depicted in FIGS. 4-5.

FIG. 4 depicts an enlarged view of the non-channeled material exhibiting anisotropic flow taken at call-out boxes A and C in FIGS. 2-3. As shown in FIG. 4, the non-channeled material exhibiting anisotropic flow can be constructed from an expanded sheet metal having a multitude of voids, where a single void is referenced by 110. The void 110 can have a long axis LA and a short axis SA. With continued reference to FIG. 4, the long axis LA of the void 110 can be oriented substantially parallel with the longitudinal length L1 of the plates 105. Without being bound to a particular theory, it is believed an efficient flow of the reactant fluid will be provided across the active area 102 where the long axis LA within the active area 102 is oriented substantially parallel with the longitudinal length L1 of the plates 105.

FIG. 5 depicts an enlarged view of the non-channeled material exhibiting anisotropic flow taken at call-out boxes B and D in FIG. 3. As shown in FIG. 5, the non-channeled material exhibiting anisotropic flow also includes the expanded sheet metal having a multitude of voids, where a single void is referenced by 110. The void 110 can have the long axis LA and the short axis SA. With continued reference to FIG. 5, the long axis LA of the void 110 can be oriented substantially parallel with the latitudinal length L2 of the plates 105. Without being bound to a particular theory, it is believed a more even distribution will be provided across the distribution area 104, and thereby across the active area 102, where the long axis LA within the distribution area 104 is oriented substantially parallel with the latitudinal length L2 of the plates 105.

Advantageously, the non-channeled distribution area of the present disclosure minimizes the area of the fuel cell 100 necessary to achieve uniform flow to the active area 102. Desirably, the non-channeled material exhibiting anisotropic flow also provides an economical alternative to conventional channeled distribution areas. Further, the non-channeled material exhibiting anisotropic flow provides enhanced support and cooling properties.

While certain representative embodiments and details have been shown for purposes of illustrating the invention, it will be apparent to those skilled in the art that various changes can be made without departing from the scope of the disclosure, which is further described in the following appended claims.

What is claimed is:

1. A fuel cell, comprising:
a pathway fluidly coupling an inlet header to an outlet header, wherein a non-channeled material exhibiting anisotropic flow is disposed within the pathway.

2. The fuel cell of claim 1, wherein the material exhibiting anisotropic flow is disposed at an active area of the fuel cell.

3. The fuel cell of claim 2, wherein the material exhibiting anisotropic flow is disposed only at the active area of the fuel cell.

4. The fuel cell of claim 1, wherein the material exhibiting anisotropic flow is disposed at a distribution area of the fuel cell.

5. The fuel cell of claim 4, wherein the material exhibiting anisotropic flow is disposed at only the distribution area of the fuel cell.

6. The fuel cell of claim 4, wherein the distribution area includes a first distribution area disposed at the inlet header and a second distribution area disposed at the outlet header, and the first distribution area and the second distribution area are disposed at terminal ends of an active area.

7. The fuel cell of claim 1, wherein the material exhibiting anisotropic flow includes an expanded metal sheet.

8. The fuel cell of claim 7, wherein the expanded metal sheet works in conjunction with a gas diffusion layer to fluidly couple the inlet header to the outlet header.

9. The fuel cell of claim 1, wherein the material exhibiting anisotropic flow includes a plurality of voids.

10. The fuel cell of claim 9, wherein each void has a short axis and a long axis, and a flow resistance in a direction of the short axis is higher than a flow resistance in a direction of the long axis.

11. The fuel cell of claim 10, wherein the flow resistance between the short axis and the long axis has a ratio between about two to one and about three to one.

12. The fuel cell of claim 10, wherein the long axis is disposed substantially parallel with a longitudinal length of the fuel cell.

13. The fuel cell of claim 12, wherein the material exhibiting anisotropic flow is disposed in an active area of the fuel cell.

14. The fuel cell of claim 10, wherein the long axis is disposed substantially parallel with a latitudinal length of the fuel cell.

15. The fuel cell of claim 14, wherein the material exhibiting anisotropic flow is disposed in a distribution area of the fuel cell.

16. The fuel cell of claim 10, wherein the long axis can alternate directions across the fuel cell between being disposed substantially parallel with a longitudinal length and being disposed substantially parallel with a latitudinal length of the fuel cell.

17. The fuel cell of claim 10, wherein the material exhibiting anisotropic flow is disposed in an active area of the fuel cell and a distribution area of the fuel cell, the long axis of the material exhibiting anisotropic flow within the active area is disposed substantially parallel with a longitudinal length of the fuel cell, and the long axis of the material exhibiting anisotropic flow within the distribution area is disposed substantially parallel with a latitudinal length of the fuel cell.

18. The fuel cell of claim 1, wherein the material exhibiting anisotropic flow includes one of elliptical voids and rhombic voids.

19. The fuel cell of claim 1, wherein the material exhibiting anisotropic flow includes one of a fibrous sheet and a woven metal mesh.

20. A fuel cell stack comprising a fuel cell according to claim 1.
